(19) United States
(12) Patent Application Publication
(10) Pub. No.: US 2008/0223836 A1
(43) Pub. Date: Sep. 18, 2008

(54) METHOD AND SYSTEM FOR LASER PROCESSING

(75) Inventor: William A. Miller, Camas, WA (US)

Correspondence Address: MARGER JOHNSON & MCCOLLOM, P.C., 210 SW MORRISON STREET, SUITE 400, PORTLAND, OR, 97204, US

(73) Assignee: EFFICERE, LLC, Vancouver, WA (US)

(21) Appl. No.: 11/684,697

(22) Filed: Mar. 12, 2007

(51) Int. Cl. B23K 26/02

(52) U.S. Cl. 219/121.78

(57) ABSTRACT

A laser processing system has a platform to support a work piece to be processed, a laser to operate on the work piece, a laser control system to control operation of the laser, and a system control to provide instructions to the laser control system based upon at least the work piece to be processed. A method of manufacture includes identifying at least a portion of a structure to be laser processed, creating a set of instructions to direct a laser to process the portion of the structure, operating the laser in accordance with the set of instructions to laser process the portion of the structure, measuring at least one of an electrical characteristic or a mechanical characteristic to obtain an actual electrical characteristic value, comparing the actual value to a target value to determine if further processing is needed, if further processing is needed, automatically adjusting operation of the laser to reprocess the portion of the structure, and repeating the measuring, comparing and adjusting until the actual value matches the target value within a given tolerance.

### CROSS-REFERENCE TO RELATED PATENTS

The following patents and applications are related, and incorporated by reference herein.

U.S. Pat. No. 6,878,901, issued Apr. 12, 2005.

U.S. patent application Ser. No. 11/104,985, filed Apr. 11, 2005.

### BACKGROUND

Laser processing of work pieces may result in higher performance structures due to the more exact nature of the structures formed or modified by laser trimming and other types of laser micromachining. Examples of higher performance may include higher signal integrity, lower loss, lower power consumption, higher density structures, better impedance matching, etc.

While laser processing of work pieces has resulting in great performance gains, it is still a somewhat inefficient process. The work piece has structures that are formed on it, such as electrical circuits, circuit features such as vias, wires, connections, etc. The work piece may be a substrate, such as a printed circuit board or ceramic substrate, a connector, or anything having conductive structures that would benefit from laser processing. For example, a printed circuit board may have metal traces for differential signals that could be laser trimmed to provide better separation between the traces, while still allowing for high density trace layouts.

In order to perform laser processing of work pieces, the laser processing must be integrated into current manufacturing processes at the initial start of the process, or the process must be adapted to more efficiently utilize the laser processing system.

### BRIEF DESCRIPTION OF THE DRAWINGS

FIG. 1 shows an embodiment of a laser processing system.

FIG. 2 shows an embodiment of a method of manufacturing a structure including laser processing.

FIG. 3 shows an embodiment of a method of manufacturing a structure using design tools and laser processing.

FIG. 4 shows an embodiment of a method to adaptively laser process a work piece.

### DETAILED DESCRIPTION OF THE EMBODIMENTS

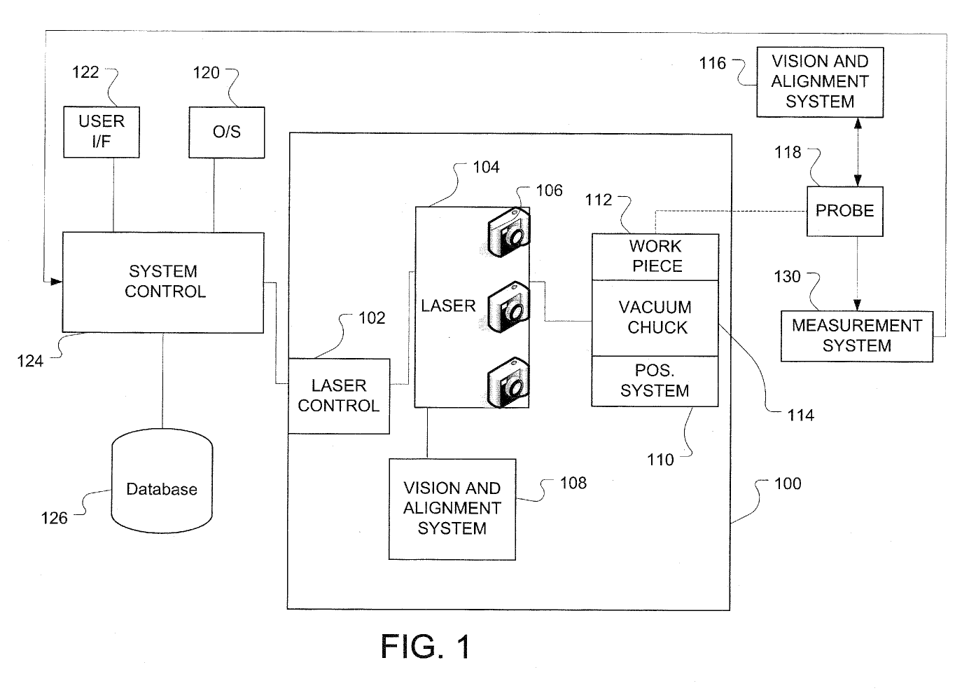

FIG. 1 shows an embodiment of a laser processing system. The laser processing system has a laser control system 100. The laser control system has a laser 104 that is controlled by a laser control 102. The laser control system 100 may include a vision and alignment system 108 for guiding the laser. The alignment operations receive input from at least one camera such as 106. The laser operates on a work piece 112, which may be held in a stable position by a vacuum chuck or other platform 114. The vacuum chuck or platform 114 may also include a positioning system that allows the platform or the work piece to be moved as needed for processing. Generally, the work piece will be mounted to the platform and positional changes will be made to the platform. However, the laser may move to adjust to the position of the work piece. In either case, the work piece will move relative to the laser.

In some embodiments, as will be discussed later, further enhancements may be made to the laser control system 100. A probe 118 may be used to detect and measure properties of the work piece before and after processing to ensure accuracy, or measurements may be made during processing to provide dynamic control of the processing. The probe 118 may be guided by a vision system 116 or laser vision system 108 in sensing data of a particular aspect of the work piece and may be a contact or non-contact probe. The vision system 116 and the laser vision system 108 may be part of one system, or may be the same system. The probe vision system may have an alignment system, which again may be part of the laser vision system 108 or part of the laser system 100. Any or all of the above operations may also be performed manually.

The data may then be converted into a measurement by the measurement system 130 and the measurement may be provided to a system control 124. The measurement provided to the system control may include location information provided from the probe vision system 116.

The system control provides and controls a user interface 122 to allow ease of use for the laser processing system, and to allow user inputs to the laser process for more customized and finer control of the process, as well as manual control. The system control in one embodiment may be a personal computer or work station. As such, the system control will generally have an operating system 120 that operates the system control.

In addition, the system control may have a database 126 to allow storage of data, such as that from the measurement system, structure information such as circuit schematics, laser operation instructions for particular pieces, properties of different types of structures such as substrates, operational results of the laser, etc., which will be discussed in more detail later. The database allows the system control to adapt operation of the laser depending upon a particular type of structure, substrate, desired properties of the resulting structure, etc. This adaptation may include comparisons of properties of the resulting structure and the desired values for those properties for further adjustment of the laser process.

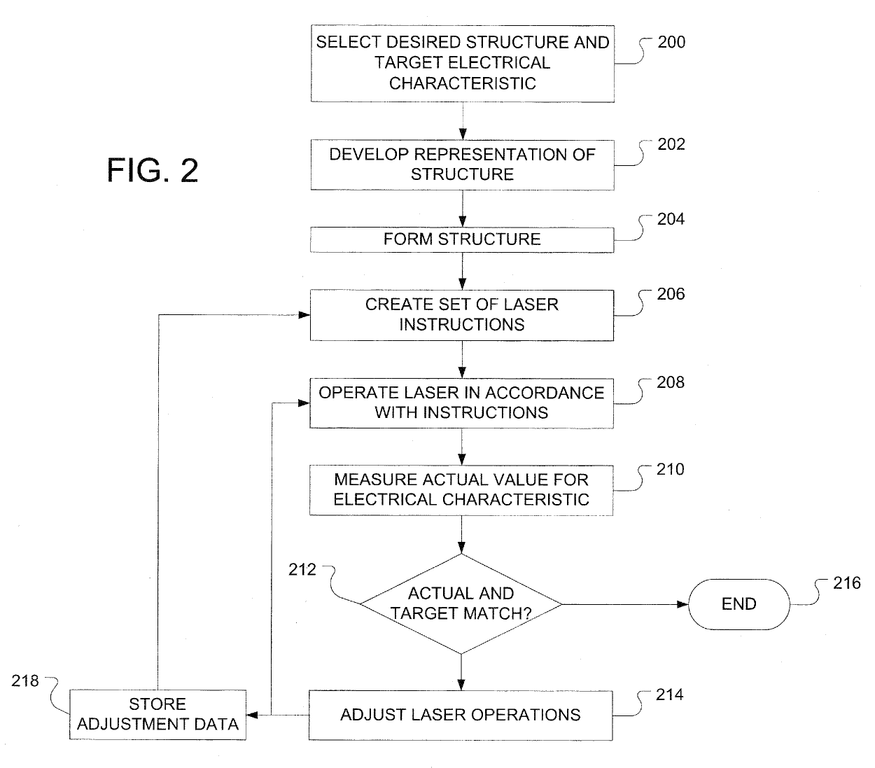

The laser system of FIG. 1 may be used to process work pieces that are created through other means or created as part of the manufacturing process flow. An example of such a process flow with an integrated laser process is shown in FIG. 2. For embodiments of the flow in which the entire process is integrated, the process would begin at 200.

At 200, the operator or process designer selects the desired structure for fabrication. The structure may include a printed circuit board or other substrate, a circuit formed on a printed circuit board, or a feature on the circuit, such as a resistor, inductor or transmission line. The designer may also select a target value for a particular electrical or mechanical characteristic, such as impedance, inductance, resistance, allowable flex, stress, pressure, etc. The process also allows selection of the target at other points in the flow.

At 202, the process develops a representation of the structure. The use of engineering design automation tools, computer aided design or computer aided manufacturing tools may perform this development. The output of these tools is a representation of the structure undergoing manufacture. The process then uses the output to form the structure at 204.

For process flows in which the structure already exists, the flow would begin at 206 where creation of the instructions to run the laser occurs. As part of the creation process at 206, a portion of the structure to be laser processed is identified. The creation of the set of instructions may involve translation from the outputs of the design tools into DXF (drawing exchange format) or other format files for further translation to tooling routes such as those provided in computer aided manufacturing tools. The tooling routes then translate into directions for the laser.

The laser processing system operates in accordance with these instructions at 208. Once the structure has undergone processing, a feedback process begins with measurement of the electrical or mechanical characteristics at 210. For example, the measurement may be performed by electrical testing, mechanical testing, or visual inspection. Generally, a visual inspection, through three-dimensional vision system, a human visual inspection or a two-dimensional vision system, will measure or identify mechanical properties, such as distances, depths, thicknesses, etc. Therefore, visual inspection generally provides information related to the mechanical characteristics of the work piece. The measurement results in an actual value for the electrical or mechanical characteristic. The process then compares the actual value to the target value at 212 and determines if the two match within a given tolerance. The tolerance may be provided automatically by the processing system or may be from a user input tolerance.

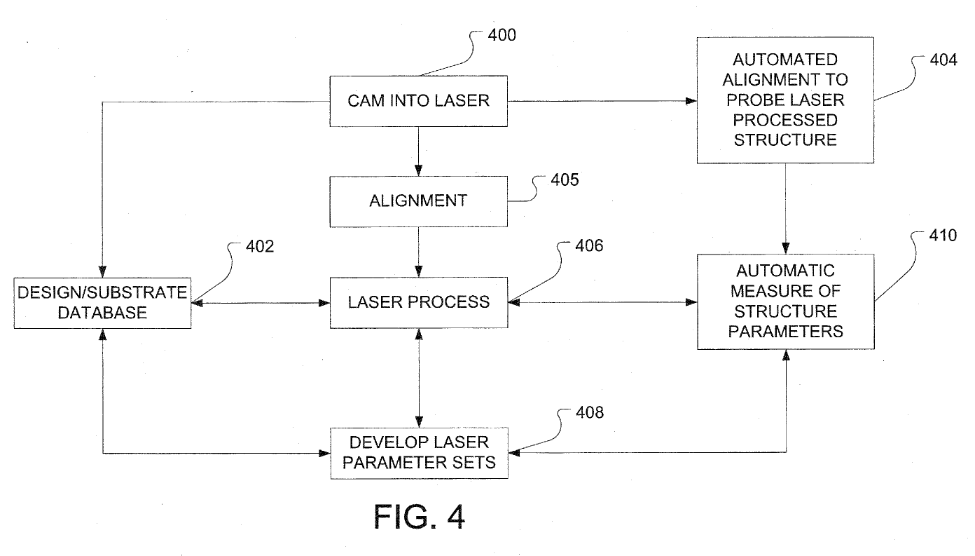

If the target and actual values match at 212, the process ends at 216. However, if the two values do not match within a given tolerance, adjustment to the laser operation may occur automatically at 214, using inputs from a database or other repository of information. In one embodiment, the work piece such as the PCB is mounted in the laser system of FIG. 1 and the system automatically processes the structure as set out above. After measurement and comparison, also done automatically, the system ‘self-corrects’ and adjusts operation and reprocesses the structure returning iteratively to 208 until the result of the comparison at 212 is a match within the tolerance. The system may store information associated with the adjustment, such as in the database 126 of FIG. 1. This will be discussed in more detail with regard to FIG. 4.

In another embodiment, the initial process is performed using manual alignment, manual operation and manual measurement. No limitation of a particular mix of manual and automatic processing is inferred nor should it be implied. Similarly, alternative flows may also occur, such as probing first, then extracting the parameters than creating the set of laser instructions based upon the parameters extracted.

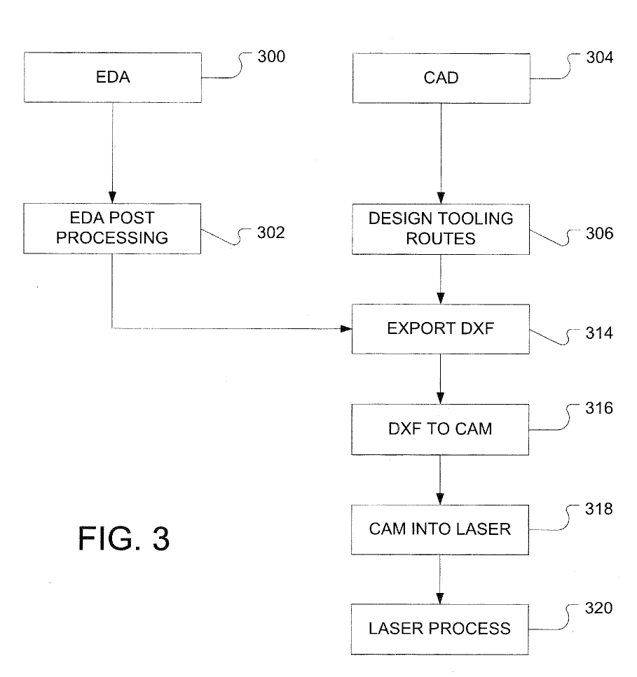

As mentioned above, this process may begin with an already existing work piece, or may actually manufacture the work piece or structure originally. An example of this is shown in FIG. 3. At 300, an engineering design automation (EDA) process develops a representation of a structure. For ease of discussion, and with no intention of limiting the scope of the claims, this structure may be a printed circuit board. The EDA process generally results in the output of a Gerber file, named for Gerber Scientific, Inc., that developed the format most widely used in photolithography of circuit boards. Other formats may be exported out of the EDA tool, such as DB++ or IPC350, the reference to the Gerber file is merely for familiarity in understanding the implementation of the embodiments.

The resulting file may be used to manufacture a structure using currently available manufacturing processing, including photolithography, mask and etch processes. The manufacturing of the structure is not shown here, but will result in the work piece having a structure at least a portion of which will be processed by the laser.

Alternatively, a computer aided design process at 304 may result in a representation of the structure. Generally, in this path, the structure is a circuit layout. Tooling routes for the laser can be generated at 306 from the circuit layout, for example, identifying at least a portion of the circuit that will be laser processed. In the EDA path, the output of the EDA process at 300 may be post-processed to allow the tooling routes to be identified for the portion of the structure to be processed.

The resulting tooling routes may then be exported at 314 as a drawing exchange format (DXF) file, currently commonly converted to computer aided manufacturing (CAM) process files, as shown at 316. Again, the reference to a DXF file is for ease of understanding and any type of drawing file may be used in the conversion to CAM process files. The CAM results at then loaded into the laser control system at 318, the work piece is mounted as needed for the processing, and at least a portion of the work piece is processed at 320, such as in the process flow of FIG. 2, as an example.

As also mentioned above, once the work piece has been processed at 320, the system may enter a feedback mode to ensure that the resulting structure meets the desired specification. The resulting processing of the structure may also have an iterative aspect to it, as mentioned above, if needed. An embodiment of this process is shown in FIG. 4.

At 400, the instructions are loaded into the laser at 400 and the laser processing is performed at 406. Over time, however, the database as shown in FIG. 1 will develop a knowledge base of structures, substrates, desired parameter targets, variations over the process, etc., that may be used to adjust operation of the laser itself, and after the laser processing and placement is finished is updated to reflect the new information. For example, in a first instance of a particular structure being processed in a particular material the laser process would commence at 406. This information would then be saved in the design/substrate database at 402. The information from both of these would then be used to develop a laser parameter set for that structure and that material at 408.

Once the structure has been processed, an optional automated alignment process at 404 may allow for an automated probe and/or measurement at 410, although manual could be done too. The automated measurement would then allow the system to test the laser processing to determine if the appropriate parameter, such as an electrical or mechanical characteristic of the system, meets target values within a particular tolerance. If the target values are not met, the system may save the measured data and then realign the structure undergoing processing to allow localized processing to meet the target values. In addition, an automated alignment process may be instituted for that particular type of work piece at 405, either for the initial processing or any reprocessing that occurs after measurement.

The next time that particular structure is to be processed in that particular material, for example, the laser process at 406 may take into account information gained from the processing and iterations to create the last instance of that structure and material from the design/substrate database, updated with information from the measurement process at 410. This would correspond to the creation of the set of instructions at 206 in FIG. 2.

The results of that particular iteration are then provided to these libraries to update their knowledge base for even finer control on the next iteration, perhaps reducing the number of iterations to one cycle instead of several. In this manner, the laser processing system of FIG. 1 becomes much more automated and efficient, overcoming current problems of inefficiency.

In addition, using the measurement system of FIG. 1, it is possible to measure the results after processing and adjusting the information in the design/substrate database and the automated tool and laser parameter sets based upon the measurements. It is possible to perform some characterization of the work piece prior to processing to adjust operation of the laser prior to actually performing the processing.

Examples of the measurement system include a time delay reflectometry (TDR) system, a profilometer, three-dimensional visual systems, contact and non-contact probes and mechanical testers. The resulting measurement could then be used to adjust operation of the laser, selection of the parameter or tool set, or adjustment to the design/substrate information stored in the database.

Thus, although there has been described to this point a particular embodiment for a method and apparatus for laser processing of work pieces, both integrated and not, it is not intended that such specific references be considered as limitations upon the scope of this invention except in-so-far as set forth in the following claims.

What is claimed is:

1. A laser processing system, comprising:
a platform to support a work piece to be processed;
a laser to operate on the work piece;
a laser control system to control operation of the laser; and
a system control to provide instructions to the laser control system based upon at least the work piece to be processed.

2. The laser processing system of claim 1, the system comprising a positioning system to automatically align the platform to the laser to provide alignment of the work piece to the laser.

3. The laser processing system of claim 1, the system comprising a positioning system to move the substrate into a position to allow at least one of electrical or mechanical probing of the work piece.

4. The laser processing system of claim 1, the system comprising at least one measurement vision system to provide data to the system control about the location of the work piece relative to a probe.

5. The laser processing system of claim 1, the system comprising a probe to provide results of laser processing.

6. The laser processing system of claim 5, the probe to provide measured values to the system control to allow the system control to adaptively control the system based upon the results.

7. The laser processing system of claim 6, wherein the system control to adaptively control the system comprises adjusting the position of the substrate relative to the laser and processing the work piece in response to the results.

8. The laser processing system of claim 6, the laser control system to compare the measured values with expected values and to adjust operation of the laser based upon the comparison between the measured values and expected values within a given tolerance.

9. The laser processing system of claim 8, the system further comprising a knowledge management system to store at least one of the results of the comparison, the measure values, the targeted values, and a tolerance.

10. The laser processing system of claim 1, wherein the work piece to be processed comprises one of a feature, a circuit, or a substrate.

11. A method of manufacture, comprising:
identifying at least a portion of a structure to be laser processed;
creating a set of instructions to direct a laser to process the portion of the structure;
operating the laser in accordance with the set of instructions to laser process the portion of the structure;
measuring at least one of an electrical characteristic or a mechanical characteristic to obtain an actual characteristic value;
comparing the actual value to a target value to determine if further processing is needed;
if further processing is needed, automatically adjusting operation of the laser to reprocess the portion of the structure; and
repeating the measuring, comparing and adjusting until the actual value matches the target value within a given tolerance.

12. The method of claim 11, comprising:
developing a representation of the structure;
determining the target value for at least one of an electrical characteristic or a mechanical characteristic for the structure; and
forming the structure prior to identifying a portion of the structure to be laser processed.

13. The method of claim 12, wherein developing a representation of a structure comprises one of either generating an input file from an engineering design automation process, receiving an output drawing file from a computer aided design process.

14. The method of claim 11, comprising storing data related to the structure, target value, and adjustments made to operation of the laser.

15. The method of claim 14, wherein creating a set of instructions comprises accessing the stored data and using the stored data to develop the set of instructions.

16. The method of claim 11, wherein identifying at least a portion of a structure to be laser processed comprises:
measuring the actual value of a characteristic of the structure;
comparing the actual value to the target value; and
analyzing the structure to determine the portion to be processed to cause the actual value to match the target value.
